(19) United States
(12) Patent Application Publication
(10) Pub. No.: US 2009/0089391 A1
(43) Pub. Date: Apr. 2, 2009

(54) Flashing email header

(75) Inventor: Jim Garrett, Lee's Summit, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: EMBARQ HOLDINGS COMPANY, LLC

(21) Appl. No.: 11/904,920

(22) Filed: Sep. 28, 2007

(51) Int. Cl. G06F 15/16

(52) U.S. Cl. 709/207

(57) ABSTRACT

A flashing email header including means for selecting on a sender's email client a receiver's email address and a desired priority for the email to be sent to the receiver's email address; means for displaying to the sender's email client at least one email header display characteristic consisting of a border setting, an internal area setting, and a text setting according to the selected priority; means for selecting on the sender's email client at least one of the border setting, the internal area setting, and the text setting; means for sending, via a common email system protocol, the email from a email-sending server to a email-receiving server; means for receiving, via a common email system protocol, the email at the receiver's email server from the email-sending server; and means for displaying the email with the at least one email header display characteristic at the receiver's email client.

### FIELD OF THE INVENTION

The field of the invention is directed to electronic messaging, and more specifically to a flashing email header.

### BACKGROUND OF THE INVENTION

The proliferation of email volume today decreases the efficiency of today's computer users. Email inboxes can become inundated with emails from all sources, such as family, friends, colleagues, co-workers, spammers, and the like requiring a user to spend inordinate amounts of time skimming these messages to determine which are important to address and which aren't.

FIG. 1 depicts a convention inbox of a typical email application showing a listing of email headers. Generally, unread emails have text that is depicted in a slightly more bold text/font as shown by the first group of emails 102 than the read emails as shown in normal text/font as shown by the second group of emails 104. The emails shown in FIG. 1 typically includes a line of text that includes the sender's name, subject line, date, and size or other information related to the emails. The emails are typically presented in order of the arrival time in the inbox with the latest email at the top of the inbox list. Because they are presented in such an order, the list of emails in the inbox includes a mixture of low-priority, medium-priority, high-priority emails, and the like. Important messages are mixed in with those of relatively little importance to the email user.

Some email applications have options features that enable a email sender to note the importance of their email to draw the attention of the email receiver. For example, Microsoft Outlook has a feature whereby the email sender may change the importance of the email from the settings, “low”, “normal,” and “high.” Emails with “high” settings may sometimes be noted as such by an exclamation point 106 to one side of the email as shown in FIG. 1. An email user must still review carefully the listing of email message headers to determine those that may be marked with such “exclamation points” and those that aren't.

### SUMMARY

The above described problems are solved and a technical advance achieved by the present Flashing Email Header. In one embodiment, the present Flashing Email Header provides a flashing email header for those emails that are of significant importance as noted by the email sender.

For example, if a company was planning an important company event and desired to notify all of its employees of the event, then the email sender would select one of the features of the Flashing Email Header. Once sent, the email message would appear in the inboxes of the employees as a flashing header to instantly notify the employees of the importance of the email. The present Flashing Email Header enables users to instantly spot those emails of greater importance without having to view each of the individual email headers for other indicia, such as exclamation points.

In another embodiment, the present Flashing Email Header provides a flashing feature in addition to a color feature for additional customization of the importance of the email message based on the desires of the email sender.

In one embodiment, the flashing email header includes a means for selecting on a sender's email client a receiver's email address and a desired priority for the email to be sent to the receiver's email address; means for displaying to the sender's email client at least one email header display characteristic consisting of a border setting, an internal area setting, and a text setting according to the selected priority, means for selecting on the sender's email client at least one of the border setting, the internal area setting, and the text setting; means for sending, via a common email system protocol, the email from a email-sending server to a email-receiving server, means for receiving, via a common email system protocol, the email at the receiver's email server from the email-sending server, and means for displaying the email with the at least one email header display characteristic at the receiver's email client.

### BRIEF DESCRIPTION OF THE DRAWINGS

FIG. 1 illustrates an exemplary screenshot from a graphical user interface (“GUI”) of a prior art email application including a listing of email message headers;

FIG. 2 illustrates a block diagram of an exemplary network of computers for an email application according to an embodiment of the present invention;

FIG. 3 illustrates an exemplary screenshot from a GUI depicting a message options display of Flashing Email Header according to an embodiment of the present invention;

FIG. 4 illustrates an exemplary screenshot from a GUI depicting a text effects display of Flashing Email Header according to an embodiment of the present invention;

FIG. 5 illustrates an exemplary screenshot from a GUI depicting an email inbox depicting email headers having effects of the Flashing Email Header according to an embodiment of the present invention;

FIG. 6 illustrates a block flow diagram for displaying and selecting flashing email header settings to an email sender according to an embodiment of the present invention; and

FIG. 7 illustrates a block flow diagram for displaying flashing email headers to an email receiver according to an embodiment of the present invention.

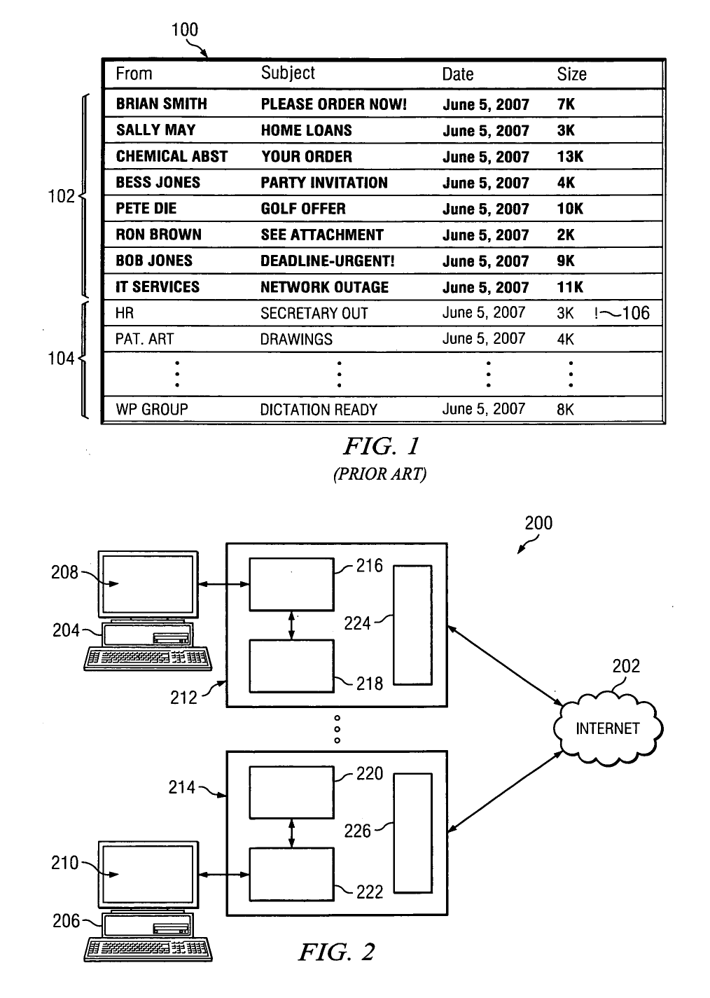

### DETAILED DESCRIPTION OF THE DRAWINGS

In the drawings, like or similar elements are designated with identical reference numerals throughout the several views and figures thereof, and various depicted elements may not be drawn necessarily to scale. FIG. 2 illustrates an embodiment 200

Conventionally, an email address is made up of several parts, such as a user name, domain name, and general. The user name is the name or pseudo name of the addressee, such as “johndoe.” The domain name is the provider or internet service provider (“ISP”) of the simple mail transfer protocol (“SMTP”) server, such as “aol” for America Online®. The general is the top level extension at the end of the email address, such as “.com,” “.net,” “.org,” and “.gov.” The “@” symbol separates the user name and the domain name, so for example, an email address could be “johndoe@aol.com.”

FIG. 2 is a block diagram of an embodiment of a standard email system for sending and receiving email on the Internet and is used to explain the Flashing Email Header. The standard email system follows a standard industry protocol for handling email on the Internet, referred to as SMTP. SMTP is a Transmission Control Protocol/Internet Protocol (“TCP/IP”) protocol for sending email between servers. Virtually all email systems that send email over the Internet use SMTP. Typically, an email is sent via SMTP to a POP3 (Post Office Protocol) server (“email server”) where an addressee retrieves the email. Because of SMTP and POP3, an addressee specifies both the POP3 server and SMTP server when they set up their email account using their email client application, such as Microsofte Outlook®, Eudora®, Pegasus, etc. An email client is generally a software application that is run on an email sender's computer 204 and an email receiver's computer 206 that displays text and menus on the monitor of the computers 204 and 206. The email client application 208 and 210 generally resides on the local drive or memory of the computers 204 and 206. The computers 204 and 206 may be in communication with standard memories, input/output (I/O) units, and a storage units. The storage units may store databases or data repositories thereon. The software may include instructions for execution by the processor for providing network connectivity information and the like. In one embodiment, the software is composed of a instructions for displaying GUI options menus and submenus to a user as further described herein.

Among other email functions, the email clients 208 and 210 generally display to a user or addressee all of the messages that are in their inbox, by displaying message headers that include the sender of the email, subject of the email, and the time and date that the email was sent. The email clients 208 and 210 also allow the user or addressee to create new messages and send them to other users or addressees. Thus, for purposes of the present Flashing Email Header, an email client 208 and 210 will be considered part of the email sender's computer 204 and email sender's computer 206, shown as email clients 208 and 210 respectively.

In FIG. 2 is shown two separate email servers, an email sender's email server 212 and an email receiver's email server 214. Typically, email servers 212 and 214 are used to handle the email service functions. For example, email servers 212 and 214 connect to the email clients 208 and 210 to send and receive email. Typically SMTP servers are for handling the outgoing mail, and POP3 or Internet Mail Access Protocol (“IMAP”) servers are for handling the incoming email. In FIG. 2 is shown an email sender's SMTP server 216 and POP3 server 218 and an email receiver's SMTP server 220 and POP3 server 222. In general, both the email sender's SMTP server 216 and the POP3 server 218 operate together to make up the email sender's email server 212. Likewise, the email receiver's SMTP server 220 and POP3 server 222 operate together to make up the email receiver's email server 214.

When a user subscribes to an ISP, they usually also gain access to that ISP's SMTP server. Users access the Internet 102 through their ISP using a dialup or high-speed line connection and a standard browser, such as Internet Explorer® or Netscape®. ISPs typically have one or more SMTP servers. SMTP servers 216 and 220 generally interact with email clients 208 and 210, respectively, to send email from an email sender to an email receiver. The ISP operates at a website address corresponding to its domain name which is addressable by users on the Internet 202. The ISP's service functions are performed for a large number of subscribers through one or more servers. The ISP or host SMTP server may interact with other SMTP servers over the Internet 202 when sending emails. When a user sets up an email account with their ISP, they set their email client 208 to the name of the ISP mail server 212, such as “johndoe.johndoe.com” When an email sender sends and email to an email receiver, the email sender's email client 208, which resides on the email sender's computer 204, typically communicates with their ISP's SMTP server 216 telling the SMTP server 216 the email address of the email sender, the address of the email receiver, and the body of the email in addition to other information. The email sender's SMTP server 216 breaks down the email receiver's address into the email receiver's user name and the domain name. If the email receiver's user name is a member of the same ISP or domain name, email server 212, as the email sender's, the SMTP server 216 will send the email to the POP3 server 218 located at the ISP for delivery to the email receiver. If the email receiver is not a member of the email sender's SMTP server 216, then the email sender's SMTP server 216 will need to communicate with another SMTP server 220, email server 214, via the Internet 202, at the email receiver's ISP or domain name.

This communication involves the email sender's SMTP server 216 inquiring at the Domain Name Server (“DNS”) for the Internet Protocol address (“IP address”) for the SMTP server for the domain, for example “yyy.com,” of the email receiver. The DNS returns to the email sender's SMTP server 216 with the IP address of one or more SMTP servers 220 for the domain name “yyy.com” of the email receiver. The email sender's SMTP server 216 then connects with the SMTP server 220 for the email receiver and inquires whether the IP address of the email receiver is at the SMTP server 220 for the email receiver. If the email receiver's IP address is at the email receiver's SMTP server 220, then the email sender's SMTP server 216 transmits the spam message to the email sender's domain name or email server 214, which is then transmitted to the email receiver's POP3 server 222, which puts the message in the inbox of the email receiver's email client 210.

To receive the email, the email receiver logs into their POP3 server 222 from their email client 210 that resides on their local computer 206 and issues a series of commands to the email receiver's POP3 server 222. The POP3 server 222 then opens the email text file and transmits the email to the email receiver's local computer 206. Generally, the POP3 server 222 acts as an interface between the email receiver's email server 214 and their email client 210. After transmitting the email to the email receiver's email client 210, the email is deleted from the email receiver's POP3 server 222. The above relating to POP3 servers can also be employed on an IMAP server as well. An IMAP server holds or stores the email instead of deleting it so that it can be accessed later. Email servers 212 and 214 also typically employ queues for holding email that is not able to be transmitted instantly due to a problem or connection with other SMTPs over the Internet.

An email application of the Flashing Email Header further may include a receiver coder/decoder, preferably in the form of instructions or software that resides on both the email sender's email server 212 and the email receiver's email server 214. The coder/decoder 224 may also operate on the email sender's computer 204 and the email receiver's computer 206 in conjunction with the email sender's email client 208 and the email receiver's email client 206. Further, the coder/decoder 224 may include hardware, computer readable memory, or both, for storing the prioritized emails.

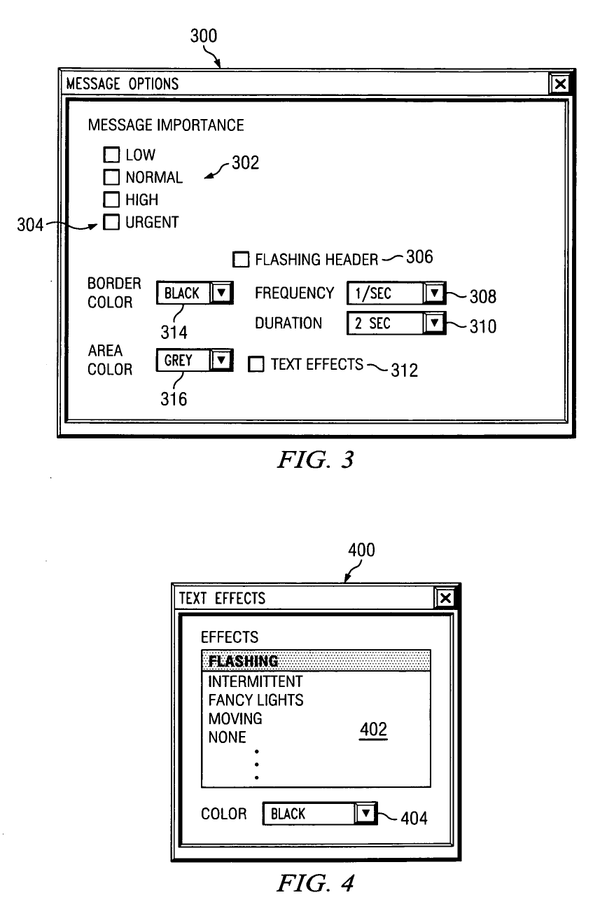

As discussed above, the email sender's email client 208 and email receiver's email client 210 further includes instructions or software for presenting options menus to the email sender and email receiver. FIG. 3 illustrates an embodiment 300 of an exemplary screenshot of a GUI depicting a message options of the Flashing Email Header. Message options 300 includes message importance options, “low,” “medium,” and “high” for conventional delivery options. If the email sender wishes to make the email urgent, then they would select the “urgent” setting 304 of the Flashing Email Header. In one embodiment, by selecting the urgent option 304, default settings relating to the way the email is displayed in the email header are chosen. So, if an email sender user wishes to have their email displayed in the email header of the email receiver's inbox, then those default, pre-selected, or otherwise effects selected by the email sender relating to the display of the email will be displayed to the email receiver in their inbox. In one embodiment, when the urgent setting 304 is selected the pre-selected settings discussed below are activated. In another embodiment, the email sender may wish to customize a particular email and may do so by selecting the individual settings noted below, such as frequency drop-down setting 308, duration drop-down setting 310, and the like.

Message options 300 of the Flashing Email Header further includes a flashing header setting 306 that when selected displays the header of the sent email in the receiver's inbox according to the desired settings of the email sender. Selecting flashing header setting 306 may then display additional setting relating to the display of the email header in the sender's inbox. For example, the Flashing Email Header may include a frequency drop-down setting 308 that defines the frequency at which the email header “flashes” or “blinks” in the email receiver's inbox as is discussed further below. The term “flash” or “flashing” means that a portion or all of a particular email header has a displayed effect that cycles on and off at a particular frequency, and further includes blinking, and the like. The frequency drop-down setting 308 depicts a setting of “1/sec,” which means that the header or text setting “flashes” or has a desired effect at that frequency. Some additional exemplary frequency drop-down setting 308 settings include: “½ sec,” “⅓ Sec,” and the like. So, for example, if an email sender selects “⅓ Sec” from the frequency drop-down setting 308, then the email header or text of the email header will “flash” for a specified duration (discussed below) once every 3 seconds.

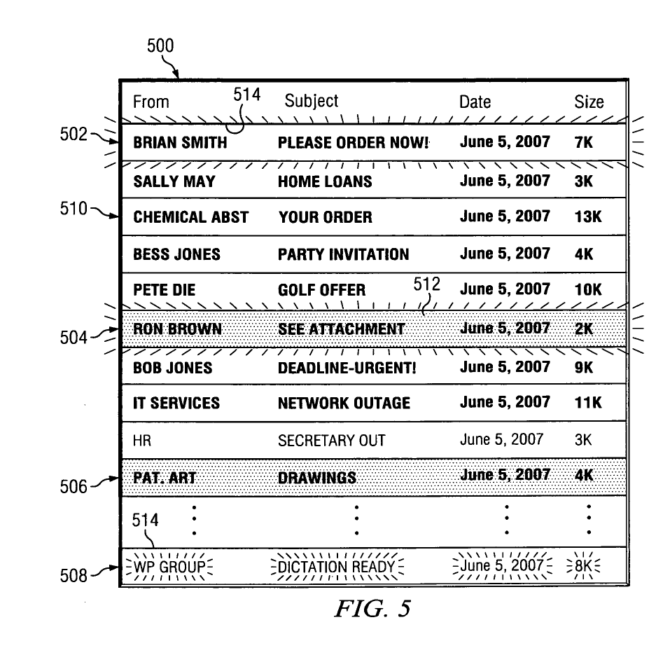

Message options 300 may also include a duration drop-down setting 310 that defines the duration of the desired effect of the displayed email header. For example, a setting of “2 seconds” will display the effect for 2 seconds and then may be paused according to the frequency drop-down setting 308. Some additional exemplary duration drop-down setting 310 setting include: “1 sec,” 3 sec,” 5 sec,” and the like. Both the frequency drop-down setting 308 and the duration drop-down setting 310 may effect either an entire email header, text or email header, or both according to the desires of the email sender. Additionally, the color for the outline of the border 514 for each email message header may be changed according to the desires of the email sender by selecting choosing a color setting 314. Although only a few borders 514 are shown in FIG. 5, border 514 refers or means the border around each particular email header. Generally, the border 514 means the perimeter lines of each email header. Further, the internal area of the email header may be a desired color by selecting such as color in the area color setting 316. This changes the color of the internal area 512 of a particular email header (See FIG. 5).

Message options 300 further may include a text effects setting 312 that when selected may display the text effects box 400 as shown in FIG. 4. FIG. 4 is an embodiment of such a text effects box that may be displayed to an email sender upon selecting text effects setting 312. It displays a effects setting 402 that may include a list of different types of effects relating to how a the text of the email header will be displayed to an email receiver. For example, a “flashing” setting is shown highlighted and this will flash the text within the email message header as discussed below. Some additional exemplary effects setting 402 include “intermittent,” “fancy lights,” “moving,” and the like. Additionally, a color of the text for the email header may be selected by the email sender by selecting a desired color setting 404. This border color setting 404 is for the text of the email headers.

FIG. 5 illustrates an embodiment 500 of an exemplary screenshot of a GUI depicting an email inbox including a listing of email headers of the Flashing Email Header. For example, the border of email header 502 is shown flashing relative to email header 510. In this embodiment, the border of the email header 502 flashes to instantly and easily notify the email receiver that the email is urgent. This may be done by the email sender selecting the color “black” in the border color setting 404, which will then “flash” the border of the email header 502. If an email sender chose to flash the border of a email header in a different color, then they would select another color contained in the border color setting 404. In email header 502, the text is shown without any flashing effects. For comparison, email header 510 is shown in a conventional slightly bolder text without any additional effects.

Further to FIG. 5, email header 504 is shown having both the border flashing and the internal area 512 of the email header 504 displayed in a desired color according to the selections of the email sender. In one embodiment, this is accomplished by selecting the area color setting 316 to a particular color and the border color setting 314 to a particular color. These colors may be the same or different depending on the desires of the email sender. Email header 506 displays the area color as described above, but does not include a flashing border. For such an effect, the email sender selects a particular area color setting 316, but may select “none” as the border color setting 314. Email header 508 displays just the text of the email header 508 flashing, but not the internal area 512 or the border 514 of email header 508. This may be accomplished by selecting a text effect, such as “flashing” in the effects setting 402 and selecting a color from the color setting 404.

As described above, an email sender may pre-select any of the settings described above relating to how they wish for the email header to be displayed in an email receiver's inbox. Further, once they are setup, then the email sender may select the setup by selecting just the “urgent” setting 304.

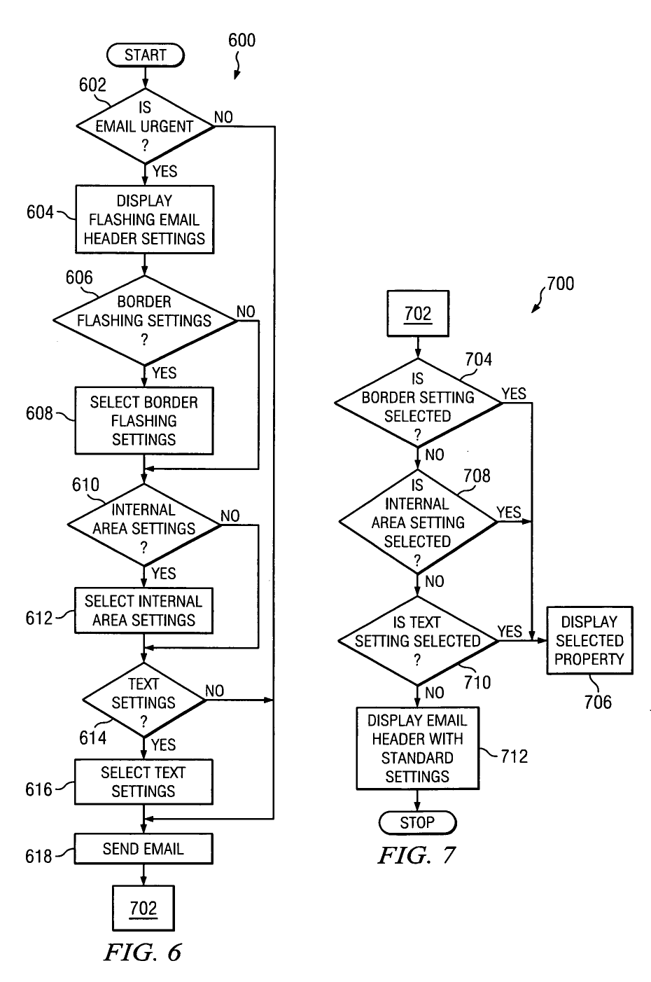

In addition to the aforementioned aspects and embodiments of the present Flashing Email Header, the present invention further includes methods for displaying email header to an email receiver. FIG. 6 illustrates an embodiment 600 of a block flow diagram of a method for displaying selections and settings to an email sender. The method 600 may be performed by hardware, software, or both, by the exemplary Flashing Email Header application. In step 602, an inquiry is made as to whether the email sender wishes to send the email with high importance, urgent, or otherwise necessary display in a manner to instantly catch the attention of the email receiver. If the answer inquiry is “no,” then the Flashing Email Header sends the email to the email receiver.

In step 604, if the Flashing Email Header displays, automatically or manually, some or all of the setting described herein, including the “urgent” setting 304, frequency drop-down setting 308, duration drop-down setting 310, text effects setting 312, border color setting 314, area color setting 316, effects setting 402, and color setting 404. In step 606, an inquiry is made whether the email sender desires to display a flashing border in the email header. If the answer to this inquiry is “yes,” then the email sender selects the displayed border color setting 314 and related frequency drop-down setting 308 and duration drop-down setting 310 at step 608. If the answer to this inquiry is “no,” then the Flashing Email Header makes an inquiry at step 610 whether the email sender desires to display an internal area setting. If the answer to this inquiry is “yes,” then the email sender selects the displayed area color setting 316 and related characteristics as described herein at step 612. If the answer to this inquiry is “no,” then the Flashing Email Header makes an inquiry at step 614 whether the email sender desires to display text settings. If the answer to this inquiry is “yes,” then the email sender selects the text effect settings 312 and related characteristics as described herein in step 616. If the answer to this inquiry is “no,” then the Flashing Email Header sends the email, automatically or manually to the email receiver.

FIG. 7 illustrates an embodiment 700 of a block flow diagram of a method for displaying flashing email headers to an email receiver. Like discussed above, the method 700 may be performed by hardware, software, or both, by the exemplary Flashing Email Header application. In step 704, an inquiry is made whether the border color setting and related characteristics have been selected by the email sender. If the answer to this inquiry is “yes,” then the border settings are displayed in email header of the inbox of the email receiver in step 706. If the answer to this inquiry is “no,” then another inquiry is made regarding internal area settings and text settings, steps 708 and 710, respectively. If the answer to either of these inquiries is “yes,” then the internal area, text settings, or both are displayed in the email header of the email message. If the answer to these two inquiries is no, then at step 712 the email header is displayed with standard or conventional settings, such as just bolder text.

There has been described a Flashing Email Header. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, flashing cross hatching, shading, or other indicia may be used to meet the desired display characteristics of the email sender without departing from the inventive concepts.

What is claimed:

1. A flashing email header comprising:
means for establishing a connection on a network between a sender's email client connected to an email-sending server and a receivers email client connected to an email-receiving server, wherein said email-sending server and said email-receiving server utilize a common email system protocol to send an email on said network;
means for selecting on said sender's email client an receiver's email address and a desired priority for said email to be sent to said receiver's email address;
means for displaying to said sender's email client at least one email header display characteristic consisting of a border setting, an internal area setting, and a text setting according to said selected priority,
means for selecting on said sender's email client at least one of said border setting, said internal area setting, and said text setting;
means for sending, via said common email system protocol, said email from said email-sending server to said email-receiving server,
means for receiving, via said common email system protocol, said email at said receiver's email server from said email-sending server, and
means for displaying said email with said at least one email header display characteristic at said receiver's email client.

2. The flashing email header of claim 1 wherein said border setting comprises:
means for flashing a border of said email header at said receivers email client.

3. The flashing email header of claim 1 wherein said internal area setting comprises:
means for flashing said internal area of said email header at said receiver's email client.

4. The flashing email header of claim 1 wherein said text setting comprises:
means for flashing said text of said email header at said receiver's email client.

5. The flashing email header of claim 1 further comprising:
means for selecting a duration that said email header display characteristic is performed.

6. The flashing email header of claim 1 further comprising:
means for selecting a frequency that said email header display characteristic is performed.

7. A method for displaying a flashing email header, comprising the steps of:
establishing a connection on a network between a sender's email client connected to an email-sending server and a receiver's email client connected to an email-receiving server, wherein said email-sending server and said email-receiving server utilize a common email system protocol to send an email on said network;
selecting on said sender's email client an receiver's email address and a desired priority for said email to be sent to said receiver's email address;
displaying to said sender's email client at least one email header display characteristic consisting of a border setting, an internal area setting, and a text setting according to said selected priority,
selecting on said sender's email client at least one of said border setting, said internal area setting, and said text setting;
sending, via said common email system protocol, said email from said email-sending server to said email-receiving server;
receiving, via said common email system protocol, said email at said receiver's email server from said email-sending server, and
displaying said email with said at least one email header display characteristic at said receiver's email client.

8. The method for displaying a flashing email header of claim 7 wherein said border setting comprises:
flashing a border of said email header at said receiver's email client.

9. The method for displaying a flashing email header of claim 7 wherein said internal area setting comprises:
flashing said internal area of said email header at said receiver's email client.

10. The method for displaying a flashing email header of claim 7 wherein said text setting comprises:
flashing said text of said email header at said receiver's email client.

11. The method for displaying a flashing email header of claim 7 further comprising:
selecting a duration that said email header display characteristic is performed.

12. The method for displaying a flashing email header of claim 7 further comprising:
selecting a frequency that said email header display characteristic is performed.

13. An email inbox comprising:
received email headers displaying at least one of a flashing border setting, a flashing internal area setting, and a flashing text setting according to said selected priority by an email sender.

14. The email inbox of claim 13 wherein said at least one of said flashing border setting, said flashing internal area setting, and said flashing text setting further comprises:
a setting to adjust the frequency of said flashing border setting, said flashing internal area setting, and said flashing text setting.

15. The email inbox of claim 13 wherein said at least one of said flashing border setting, said flashing internal area setting, and said flashing text setting further comprises:
a color setting to adjust the displayed color of said flashing border setting, said flashing internal area setting, and said flashing text setting.

16. The email inbox of claim 13 wherein said at least one of said flashing border setting, said flashing internal area setting, and said flashing text setting further comprises:
a setting to adjust the frequency of said flashing border setting, said flashing internal area setting, and said flashing text setting.

17. A user interface comprising:
an email header characteristic display for displaying to an email sender at least one of a border setting, an internal area setting, and a text setting according to a selected priority of an email to be sent by said email sender,
a selection device to designate at least one of said border setting, said internal area setting, and said text setting; and
an email display for flashing said designated at least one of said border setting, said internal area setting, and said text setting.

18. The user interface of claim 17 wherein said at least one of said flashing border setting, said flashing internal area setting, and said flashing text setting further comprises:
a setting to adjust the frequency of said flashing border setting, said flashing internal area setting, and said flashing text setting.

19. The user interface of claim 17 wherein said at least one of said flashing border setting, said flashing internal area setting, and said flashing text setting further comprises:
a color setting to adjust the displayed color of said flashing border setting, said flashing internal area setting, and said flashing text setting.

20. The user interface of claim 17 wherein said at least one of said flashing border setting, said flashing internal area setting, and said flashing text setting further comprises:
a setting to adjust the frequency of said flashing border setting, said flashing internal area setting, and said flashing text setting.
